(19) United States
(12) Patent Application Publication
(10) Pub. No.: US 2004/0081291 A1
(43) Pub. Date: Apr. 29, 2004

(54) Telephony system with subliminally keyed speech recording

(76) Inventor: Peter Tavernese, Kings Park, NY (US)

Correspondence Address: DOCKET CLERK, P.O. DRAWER 800889, DALLAS, TX, 75380, US

(21) Appl. No.: 10/636,300

(22) Filed: Aug. 7, 2003

Related U.S. Application Data
(63) Continuation of application No. 09/456,028, filed on Dec. 3, 1999, now abandoned.

(51) Int. Cl. H04M 1/64

(52) U.S. Cl. 379/67.1

(57) ABSTRACT

A telephony system sends an outgoing message to a caller and expects to receive a reply message. In order to be prepared to process the reply, a speech input unit is activated by a subliminal keying signal. The keying signal is provided in time relation to the outgoing message on the same transmission path as the outgoing message. The keying signal is both subliminal, so it is “heard” by the speech input unit and not by the caller, and has a signal pattern unlike normal speech, so as to avoid false keying of the input unit. The input unit can thus be activated at an appropriate time to be ready to process a reply. This avoids inefficiencies of a continuously activated input unit and loss of opening elements of a reply message due to the latent period of a voice-activated input unit.

### RELATED INVENTIONS

(Not Applicable)

### FEDERALLY SPONSORED RESEARCH

(Not Applicable)

### BACKGROUND OF THE INVENTION

This invention relates to telephony systems which process user replies and, more particularly, such systems with reduced latent periods prior to initiating recording of user replies received in response to outgoing messages.

Telephony systems of different types are available for a variety of applications. The general design, operation and capabilities of such systems are well known to skilled persons. A typical application involves informational inquiries by callers using an “800” type telephone service.

In response to an incoming call from a caller, the system transmits an outgoing message to prompt the caller to provide additional information as needed to process the caller's inquiry on account status, an order for merchandise, etc. The caller is thus solicited to reply to the outgoing message and the system is typically arranged to record or otherwise process the caller's reply.

In order to process the caller's reply, a speech input unit must be in an active state (e.g., turned on). Alternative approaches have been used in controlling the active state of the input unit so that it is able to record or otherwise process the reply. The speech input unit may be kept in an active state at all times while the telephony system is in use. However, this tends to be an inefficient use of recording/processing facilities. Alternatively, the speech input unit may be arranged to be activated when the beginning of a reply is sensed. However, such speech activated operation tends to result in loss of a small opening portion of the spoken reply. This result occurs because responsive action takes a finite period of time and activation is thus delayed or subject to a latency effect. Prior systems have generally required some tradeoff between efficiency of operation and accuracy of full message recording, on reception of spoken replies from a caller.

Objects of the present invention are, therefore, to provide new and improved systems and methods having one or more of the following advantages and characteristics:

keyed speech input recording/processing;

keyed activation in advance of user reply;

keying signal transmission on the same transmission path with outgoing messages;

subliminal keying signals;

keying signal format not resembling speech;

internal keying signals using frequencies outside public network capabilities; and

single transmission path for messages and keying signals, without caller perception of keying signals.

### SUMMARY OF THE INVENTION

In accordance with the invention, in a telephony system arranged to process a user reply to an outgoing message, a subliminal keying system includes speech output and input units. The speech output unit is arranged to provide both an outgoing message for transmission to the user and an associated subliminal keying signal. The speech input unit is responsive to a user reply to the outgoing message and is arranged to be activated by the subliminal keying signal in preparation for processing the user reply.

Typically, the subliminal keying signal is transmitted within the telephony system on the same transmission path as the outgoing message and is characterized by a signal pattern unlikely to occur in signals representative of speech. Pursuant to the invention, the speech output unit is arranged to provide a subliminal keying signal characterized by one of: low amplitude; low energy content; signal components of frequency too high for transmission over a public telephone network; signal components of frequency too low for transmission over a public telephone network; signal components of low amplitude and duration so as to be substantially inaudible.

Also in accordance with the invention, in a telephony system arranged to process a user reply to an outgoing message, a subliminal keying method includes the steps of:

(a) providing an outgoing message and transmitting such message to the user;

(b) providing a subliminal keying signal in predetermined time relation to the outgoing message, the subliminal keying signal characterized by low audibility to the user;

(c) activating a speech input processing unit in response to the subliminal keying signal; and

(d) processing the user reply in the processing unit.

For a better understanding of the invention, together with other and further objects, reference is made to the accompanying drawings and the scope of the invention will be pointed out in the accompanying claims.

### BRIEF DESCRIPTION OF THE DRAWINGS

FIG. 1 is a block diagram of a telephony system employing a subliminal keying system in accordance with the invention.

FIG. 2 is a flow chart useful in describing a subliminal keying method pursuant to the invention.

### DESCRIPTION OF THE INVENTION

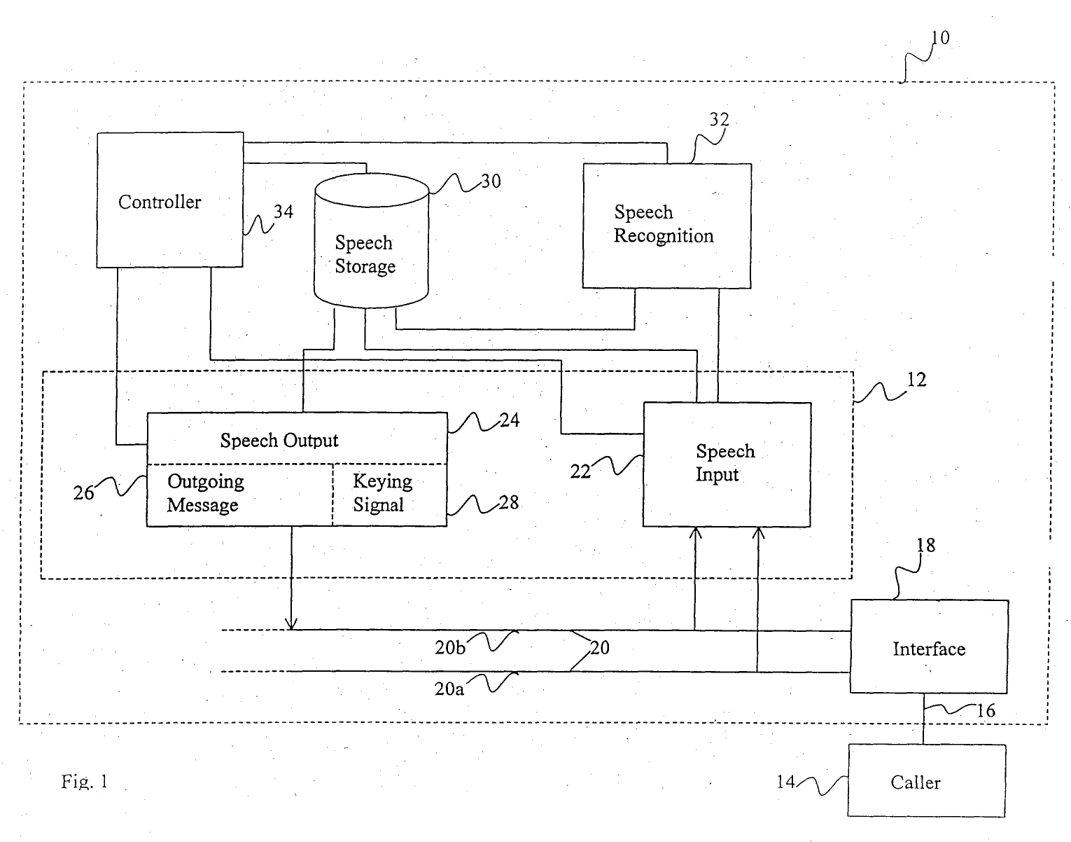

FIG. 1 illustrates an embodiment of a telephony system 10, which includes a subliminal keying system 12, in accordance with the invention. As shown, system 10 is arranged to receive calls from an individual caller via device 14, which may be a telephone instrument, for example. Communication path 16 shown linking device 14 and system 10 may comprise a public telephone network or other suitable communication facility enabling two-way communication. The system will typically be configured to serve a plurality of callers initiating individual calls via “800” type service or otherwise.

As shown, device 14, which may be arranged for transmission and reception of voice messages in analog or digital format, is coupled to interface unit 18. In this example, interface unit 18 is coupled to a bus configuration 20. Bus configuration 20 may be an industry standard type of bus or highway configuration, MVIP or SCSA for example, operating with PCM (pulse code modulation) to provide efficient internal signal transmission in digital format between elements of the system and may employ a known encoding format, such as linear, ulaw or alaw encoding. Bus configuration 20, illustrated as including individual input and output channels 20a and 20b, respectively handling incoming and outgoing messages and signals, may be provided in any appropriate format employing any desired number of transmission paths. Interface unit 18 is arranged to convert outgoing messages and signals on output channel 20b to a format suitable for transmission (e.g., analog or digital) over telephone network 16 to a caller via device 14. Correspondingly, incoming messages, from a caller via telephone network 16, are converted by interface unit 18 to PCM or other signals in suitable encoded format for transmission on input channel 20a.

As illustrated in FIG. 1, subliminal keying system 12 of telephony system 10 includes speech input unit 22 and speech output unit 24, each coupled to bus configuration 20. As shown, unit 24 includes outgoing message and keying signal subportions and is coupled to provide outgoing messages/signals to output channel 20b. Unit 22 is illustrated as having two couplings to bus configuration 20 (e.g., to respective input and output channels 20a and 20b) to enable speech input unit 22 to be responsive to both incoming messages and outgoing signals.

Speech input unit 22 is arranged to capture digital format messages carried by input channel 20a and keying signals carried by output channel 20b. Unit 22 is thus enabled to process incoming replies from callers and, in preparation therefor, to be activated by subliminal keying signals from unit 24, as will be further described. Unit 22 may be a microprocessor-based unit including memory and other suitable capabilities arranged to capture and partially or temporarily store incoming messages. As shown, unit 22 is coupled to a speech storage unit 30 (e.g., employing electromagnetic or other large capacity storage capability), a speech recognition unit 32, and controller 34. Depending upon the particular application, the system may be subject to overall operating control of a computer-based controller unit 34 and speech recognition unit 32 may be employed to recognize/interpret the meaning of incoming messages. Each of the units shown in FIG. 1 may be provided in appropriate form and functionality by skilled persons once having an understanding of the invention as described.

Speech output unit 24 is arranged to convert speech data (e.g., pre-recorded or synthesized text-to-speech) to a form that can be transmitted in digital format over bus configuration 20. Typically, under overall control of controller 34, unit 24 thereby provides outgoing messages for transmission to users, such as a caller via device 14. Thus, once a suitable response. to an incoming call is determined (e.g., by controller 34 in response to message data from units 30 and 32) outgoing message portion 26 of unit 24 assembles or otherwise provides an outgoing message in digital format and delivers it to bus configuration 20 for transmission to the caller. Unit 24, via keying signal; portion 28, also provides a subliminal keying signal and delivers it to bus configuration 20 for transmission to speech input unit 22. Keying signal portion 28, which may be provided by skilled persons with an understanding of the invention, is nevertheless considered to provide a unique function and capability as part of the FIG. 1 system.

As noted, speech input unit 22 is arranged to be activated by a subliminal keying signal in preparation for processing a user reply. Correspondingly, speech output unit 24 is arranged to provide both an outgoing message for the user and an associated subliminal keying signal. Provision and use of such a keying signal is a departure from prior techniques dependent upon either use of voice activated input processing (subject to latency delay and inability to reliably capture opening speech elements) or use of continuously active input processing (subject to decreased efficiency of operation).

An example of a presently preferred form of subliminal keying signal, on a linear 255 value scale, consists of a signal including one sample of value five, followed by 63 samples of value one. This signal is thus a composite pulse-type signal of low amplitude relative to human perception, with a distinctive signal pattern characteristic which is unlikely to occur in the course of typical signals representative of speech. In a ulaw encoding format the same form of signal is represented by one sample of value OXFA, followed by 63 samples of value one, or in alaw format as one sample of value O×51, followed by 63 samples of value O×54. With this example, many variations of signals usable for the present purpose can be provided by skilled persons.

The input unit 22 can thus be activated in advance of the time at which a reply can be expected to be received from a caller. Depending upon the particular application and experience with caller reply timing in that application a caller could, for example, be expected to reply (a) after the outgoing message is completed, (b) after a key phrase in the outgoing message, (c) at any time during the course of the outgoing message. Accordingly, unit 24 can provide a subliminal keying message in a predetermined time relation to an outgoing message so that unit 22 is activated at one of the following points in time: at the beginning, prior to the midpoint, after the midpoint, at the end, after the end of the outgoing message, as appropriate to the embodiment and application of a system using the invention.

With use of the invention, as described, the keying signal can be provided by unit 24 as an output signal on the same transmission path as used for. the outgoing message to the caller (e.g., output channel 20b). The unit 22 “hears” and is activated by the keying signal. The caller, on the other hand, is prevented from consciously hearing the signal as a result of keying signal characteristics, system constraints, or a combination thereof.. This objective of keeping the keying signal “subliminal” insofar as the caller or system user is concerned, can be accomplished by a number or combination of techniques. As in the specific example provided above, the keying signal may be of such low amplitude as not to be consciously perceivable by a caller, as a practical matter. Alternatively, a keying signal for transmission from unit 24 to unit 22 within the telephony system may utilize frequency components too high or too low for transmission on the public telephone system used by the caller (e.g., outside the frequency passband of the public network). Also, a filter capability may be included in interface unit 18, so that if the keying signal is constrained to particular frequency characteristics the unit 18 filter will attenuate the keying signal as passed to the caller. With an understanding of the invention, many variations enabling passing a signal from one unit to another, while presenting at most only a low perceptibility representation of the keying signal to the caller, may be employed by skilled persons. For present purposes all such variations are termed “subliminal”, regardless of how achieved.

It will now be appreciated that use of systems employing subliminal keying signals as described provide a number of operating advantages. Speech input unit 22 can remain inactive (e.g., turned off) until activated in anticipation of a user reply. Activation can be provided in a time relation effective to precede the user reply and thereby fully capture the opening portion of the reply. Use of a subliminal keying signal permits transmission of that signal on the same transmission path as an outgoing message to a caller. A dual path is not required and the caller does not discern the presence of the keying signal. By use of a keying signal characterized by a signal pattern unlikely to occur in speech signals, reliable keying is enabled and false keying is avoided. While further signals could be utilized to deactivate the speech input unit 22, it is expected that cessation of incoming speech signals, with or without a trailing time delay preceding deactivation, will typically provide an adequate basis for deactivation after a user's reply is received. The speech input unit 22 will then typically revert to a stand-by status, subject to activation by the next subliminal keying signal.

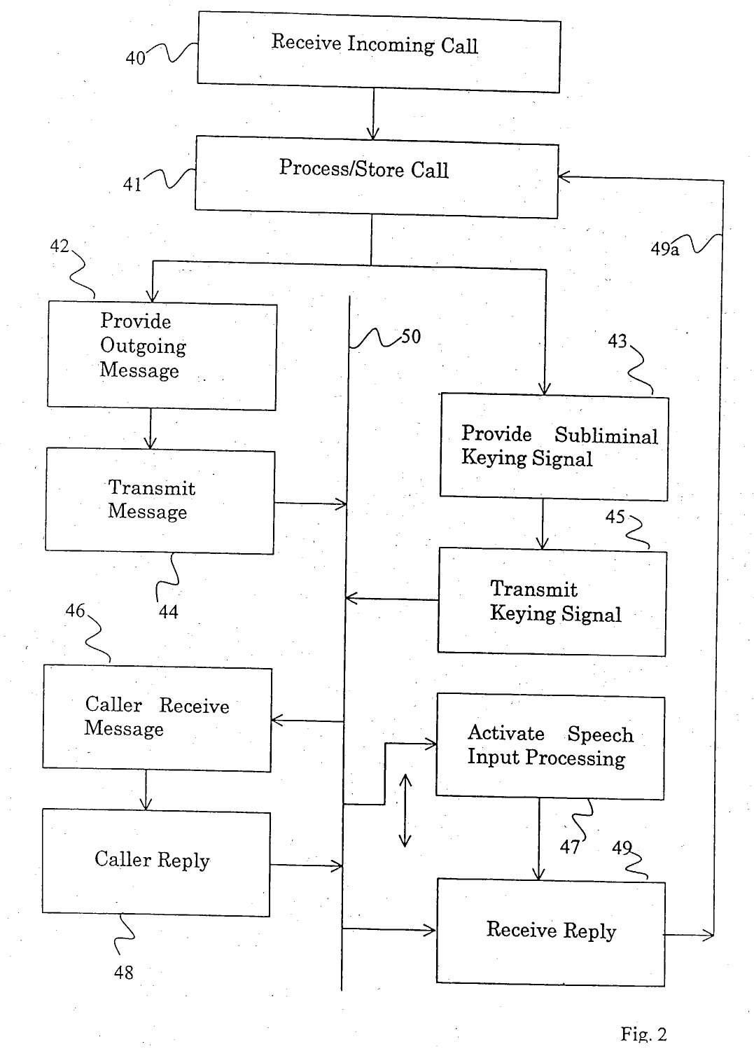

Operational understanding of the invention will be enhanced by consideration of a subliminal keying method pursuant to the invention. An exemplary method as illustrated in FIG. 2 includes the following steps.

At 40, an incoming call is received from a user of the system. With reference to the system of FIG. 1, a caller may transmit an “800” type informational call, via telephone device 14 and public network 16, to system interface unit 18.

At 41, the incoming call is coupled to speech input unit 22 and typically stored and processed so as to enable a suitable responsive outgoing message to be identified/determined under the control of controller 34. For this initial caller message (which is not a reply to an outgoing message) unit 22 may be voice activated or otherwise activated in a suitable known manner.

At 42, the responsive outgoing message is provided by speech output unit 24 for transmission for reception by the caller. More particularly, the outgoing message portion 26 of unit 24 may convert speech data representative of the responsive message to a form suitable for transmission in digital format over bus configuration 20. For this purpose, the speech data may be made available from pre-recorded messages or concatenated message elements, may represent synthesized text-to-speech, or may otherwise be provided. At 43, a subliminal keying signal of the type previously described is provided.

In FIG. 2, line 50 is a representation of a conceptual time line interrelating elements of the method. At 44, the outgoing message is transmitted for reception by the caller. At 45, the subliminal keying signal is transmitted via the same internal transmission path. The keying signal is transmitted in predetermined time relation to the outgoing message, as previously discussed.

At ⁴⁶,-the caller receives the outgoing message and at 47 the speech input processing unit is activated in preparation for processing a reply from the caller. The time relation between steps 46 and 47 is predetermined based on the embodiment and application of the system and the operating conditions. Efficiency is affected if input speech processing is activated earlier than required, however, opening elements of a reply message will be lost if activation is late. In certain applications some callers may be expected to reply by talking over an outgoing message as soon as it starts. In other cases an outgoing message may include unique information responsive to a caller inquiry, so that typically a caller will listen to the entire outgoing message before replying. Pursuant to the invention, as represented by arrow 47a the time relation of the keying signal can be selected so speech input processing is activated at the beginning, prior to the midpoint, after the midpoint, at the end or after the end of the outgoing message.

At 48, the caller transmits a reply and at 49 the reply is received by speech input unit 22, which has already been activated by the subliminal keying signal. Via path 49a, the reply message is processed and stored and steps 41-49 are repeated in order to provide for timely activation of the speech input processing in preparation-for reception of a further reply from the caller. Of course, if no further outgoing message is provided steps 41-49 need not be repeated.

In operation of the method pursuant to the example represented by FIG. 2, it will be appreciated that while the keying signal is transmitted on the same path as the outgoing message, the subliminal nature of the keying signal and its processing as already discussed are effective to cause the keying signal to be basically inaudible to the caller. Thus, while some representation of the keying signal may reach the caller, its characteristics at that point will be such that the caller will typically be unaware of the presence of the keying signal.

While there have been described the currently preferred embodiments of the invention, those skilled in the art will recognize that other and further modifications may be made without departing from the invention and it is intended to claim all modifications and variations as fall within the scope of the invention. For example, while keying signal portion 28 is illustrated as included within speech output unit 24, a keying signal could be generated in a different manner from a different system location under control of controller 34 to produce the desired result.

What is claimed is:

1. In a telephony system. arranged to process a user reply to an outgoing message, a subliminal keying system comprising:
a speech output unit arranged to provide both an outgoing message for transmission to the user and an associated subliminal keying signal; and
a speech input unit responsive to a user reply to said outgoing message, said speech input unit arranged to be activated by said subliminal keying signal in preparation for processing the user reply.

2. A subliminal keying system as in claim 1, wherein the subliminal .keying signal is transmitted within the telephony system on the same transmission path. as the outgoing message.

3. A subliminal keying signal as in claim 1, wherein the speech output circuit is arranged to provide a subliminal keying signal characterized by both low audibility to said user and pulsed signal format.

4. A subliminal keying signal as in claim 1, wherein the speech output unit is arranged to provide a subliminal keying signal characterized by a signal pattern unlikely to occur in signals representative of speech.

5. A subliminal keying system as in claim 4, wherein the speech output unit is arranged to provide a subliminal keying signal characterized by at least one of: low amplitude; low energy content; signal components of frequency too high for transmission over a public telephone network; signal components of frequency too low for transmission over a public telephone network; signal components of low amplitude and duration so as to be substantially inaudible.

6. A subliminal keying system as in claim 1, wherein the speech output unit is arranged to provide said subliminal keying signal in predetermined time relation to the outgoing message.

7. A subliminal keying system as in claim 6, wherein the subliminal. keying signal is effective to activate the speech input unit at one of: the beginning, prior to the midpoint, after the midpoint, at the end, after the end, of the outgoing message.

8. A subliminal keying system as in claim 1, wherein the subliminal keying signal is transmitted within the telephony system on the same transmission path as the outgoing message, and additionally comprising:
an interface unit responsive to the outgoing message and the subliminal keying signal and arranged to couple signals for reception by the user, the interface unit having a response characteristic effective to limit transmission of the subliminal keying signal to the user.

9. A subliminal keying system as in claim 8, wherein said response characteristic of the interface unit includes one of: a high frequency cut-off, a low frequency cut-off, a filter characteristic, effective to attenuate-the subliminal keying signal.

10. In a telephony system arranged to process a caller reply to an outgoing message, a subliminal keying system comprising:
a speech output unit arranged, in response to an incoming call from the caller, to provide both an outgoing message for transmission to the caller and a subliminal keying signal in time relation to the outgoing message;
a speech input unit responsive to a caller reply to said outgoing message, said speech input unit arranged to be activated by said subliminal keying signal in preparation for processing the caller reply;
an interface unit responsive to the outgoing message and the subliminal keying signal and arranged to couple signals from and to the caller; and
a bus configuration including an output channel to couple both the outgoing message and the subliminal keying signal to the speech input unit and the interface unit, and an input channel to couple the caller reply to the speech input unit for processing;
said subliminal keying signal characterized by both low audibility to said user and a signal pattern unlikely to occur in signals representative of speech.

11. A subliminal keying system as in claim 10, wherein the speech output unit is arranged to provide said subliminal keying signal in predetermined time relation to the outgoing message.

12. A subliminal keying system as in claim 11, wherein the subliminal keying signal is effective to activate the speech input unit at one of: the beginning, prior to the midpoint, after the midpoint, at the end, after the end, of the outgoing message.

13. In a telephony system arranged to process a user reply to an outgoing message, a subliminal keying method comprising the steps of:
(a) providing an outgoing message and transmitting such message to the user;
(b) providing a subliminal keying signal in predetermined time relation to the outgoing message, the subliminal keying signal characterized by low audibility to the user;
(c) activating a speech input processing unit in response to the subliminal keying signal; and
(d) processing the user reply in the processing unit.

14. A subliminal keying method as in claim 13, wherein in step (a) the outgoing message is provided in response to an incoming call from the user.

15. A subliminal keying method as in claim 13, wherein in step (b) the subliminal keying signal is provided in a time relation to the outgoing message effective to activate the speech input processing unit in step (c) at one of: the beginning, prior to the midpoint, after the midpoint, at the end, after the end, of the outgoing message.

16. A subliminal keying method as in claim 13, wherein in step (d) a user reply in the form of an audio signal is converted to a digital signal for storage.

17. A subliminal keying method as in claim 13, wherein the outgoing message and subliminal keying signal provided in steps (a) and (b) are both transmitted on the same transmission path within the telephony system.

18. A subliminal keying method as in claim 13, wherein step (d) includes receiving said user reply at a time T and in step (c) activation occurs prior to time T.

19. A subliminal keying method as in claim 13, wherein step (b) includes providing a subliminal keying signal characterized by a signal pattern unlikely to occur in signals representative of speech.

20. A subliminal keying method as in claim 19, wherein step (b) includes providing a subliminal keying signal characterized by one of: low amplitude; low energy content; signal components of frequency too high for transmission over a public telephone network; signal components of frequency too low for transmission over a public telephone network; signal components of low amplitude and duration so as to be substantially inaudible.
